(19) United States
(12) Patent Application Publication
(10) Pub. No.: US 2026/0296442 A1
(43) Pub. Date: Oct. 1, 2026

(54) VEHICLE AND METHOD FOR CONTROLLING A VEHICLE

(71) Applicant: ZF CV Systems Global GmbH, Bern (CH)

(72) Inventors: Steffen Gerlach, Hannover (DE); Michael Grossmann, Horgenzell (DE)

(21) Appl. No.: 19/688,188

(22) Filed: May 26, 2026

Related U.S. Application Data
(63) Continuation of application No. PCT/EP2024/080219, filed on Oct. 25, 2024.

(30) Foreign Application Priority Data
Nov. 23, 2023 (DE) 10 2023 132 647.3

(51) Int. Cl. B60W 30/18; B60W 10/04; B60W 10/08; B60W 10/18; B60W 10/20; B60W 10/22; B60W 10/30; B60W 40/13; B60W 50/00; E02F 3/32; E02F 9/20

(52) U.S. Cl. CPC B60W 30/18172; B60W 10/04; B60W 10/08; B60W 10/18; B60W 10/20; B60W 10/22; B60W 10/30; B60W 40/13; B60W 50/0097; E02F 3/32; E02F 9/2025; B60W 2040/1315; B60W 2300/17; B60W 2520/26; B60W 2552/15; B60W 2552/30; B60W 2555/20; B60W 2556/10; B60W 2556/45; B60W 2710/08; B60W 2710/18; B60W 2710/20; B60W 2710/22; B60W 2720/106

(57) ABSTRACT

A vehicle including a first axle unit; a first dynamic unit assigned to the first axle unit, wherein the first dynamic unit is one of a brake, a drive and a steering system; a second axle unit; a center of mass; and a control device. The control device is configured to shift the center of mass, and to ascertain a grip improvement request for the first axle unit and for a dynamic operation to be carried out via the first dynamic unit and, in response to the grip improvement request for the first axle unit, to shift the center of mass toward the first axle unit.

### CROSS-REFERENCE TO RELATED APPLICATIONS

This application is a continuation application of international patent application PCT/EP2024/080219, filed Oct. 25, 2024, designating the United States and claiming priority from German application 10 2023 132 647.3, filed Nov. 23, 2023, and the entire content of both applications is incorporated herein by reference.

### TECHNICAL FIELD

The disclosure relates to a vehicle and to a method for controlling a vehicle.

### BACKGROUND

In a vehicle, the grip of the tires may be impaired during a dynamic operation for various reasons. The term “dynamic operation” refers generally to a dynamic situation. The dynamic operation may be, for instance, acceleration by a drive, braking by a brake, or a steering movement by a steering system. Grip impairment may arise, for example, on dry roads under high forces, on wet roads, on roads covered with leaves or dirt, on roads covered with ice or snow, and generally on roads exhibiting unfavorable conditions, for example “off-road” conditions.

Reduced grip is detrimental, inter alia, to the safety of the vehicle and of persons in the vehicle, in particular with regard to braking. If the brake is configured for energy recovery, for example as a recuperation brake, reductions in grip also result in the amount of energy that can be recovered being limited. Safety-related drawbacks may also arise when accelerating and steering in the event of a reduction in grip.

DE 10 2019 124 651 A1 describes a towing vehicle-trailer combination, which is equipped with a starting aid device that is configured to increase an axle load of a first axle relative to an axle load of a second axle in the event of a starting aid request. This is intended to provide an improved effect in relation to the traction of the vehicle and to provide more effective control of the air suspension of the trailer axles of the vehicle in relation to the starting aid function.

### SUMMARY

The disclosure addresses the problem of improving the grip in a vehicle for a dynamic operation, for example for acceleration, braking or a steering movement.

This problem is solved by a vehicle by various embodiments of the disclosure.

According to various embodiments, a vehicle includes a first axle unit and a first dynamic unit assigned to the first axle unit. The dynamic unit is a brake, a drive or a steering system. The vehicle also includes a second axle unit, a vehicle frame on which the first axle unit and the second axle unit are arranged, a center of mass, and a control device which is configured to shift the center of mass. The first and the second axle unit may each have one or more axles. Furthermore, the vehicle may also have further axle units.

The control device is configured to ascertain a grip improvement request for the first axle unit and for a dynamic operation to be carried out via the first dynamic unit and, in response to the grip improvement request for the first axle unit, to shift the center of mass toward the first axle unit.

As a result of the center of mass being shifted toward the first axle unit, a weight force applied to the first axle unit is increased. Thus, a respective axle load on the one or more axles of the first axle unit is increased.

The targeted increase in the axle load on the first axle unit results in an increase in the grip of tires arranged on this axle with the ground. This is achieved in a particularly simple manner by shifting the center of mass, for instance using devices that are already present on the vehicle and are movable by the control device. Thus, the grip can be increased without additional hardware, but merely by way of advantageous control of the existing hardware.

The grip improvement request can be generated, for example, in response to a dynamic-operation activation request, for instance a brake request, an acceleration request or steering request, and/or, for example, when a reduction in grip is ascertained or is probable.

If the dynamic unit is a brake and the dynamic operation is braking, the increase in grip has the result of shifting the slipping of the tires of the first axle unit of the vehicle to greater vehicle decelerations. If the brake is a recuperation brake, energy can be recovered by recuperation in a greater deceleration range.

If the dynamic unit is a drive and the dynamic operation is acceleration, the increase in grip has the result of shifting the slipping of the tires of the first axle unit of the vehicle to greater vehicle accelerations. This improves the transmission of a drive torque.

The vehicle may have, for example, a drive which is assigned to the first axle unit, for example an electric drive or an internal combustion engine. An electric drive can be provided, for example, as the only drive of the respective axle unit or axle of the vehicle, or can be provided as an additional drive, for example together with an internal combustion engine. An electric drive can also form or include a recuperation brake, that is, take on a braking function.

If the dynamic unit is a steering system and the dynamic operation is a steering movement, the increase in grip has the result of shifting the slipping of the tires of the first axle unit of the vehicle to greater lateral forces, in particular to higher speeds and smaller steering angles. Safety is thus increased.

The vehicle may also have several or all of the abovementioned dynamic units, and these can also be assigned to the first axle unit. One or more dynamic units may also be additionally provided and be assigned to the second axle unit.

According to an embodiment, the vehicle includes a vehicle frame, wherein, via the control device, a distance of the first axle unit relative to the vehicle frame and/or a distance of the second axle unit relative to the vehicle frame is changeable, wherein the control device is configured to shift the center of mass by changing the distance of the first axle unit relative to the vehicle frame and/or the distance of the second axle unit relative to the vehicle frame. By changing the distances, the vehicle tilts slightly forward or backward and thus the center of mass also tilts, that is, shifts. This embodiment is particularly simple and is advantageous particularly in vehicles with a high center of mass, as is the case, for example, in trucks. The embodiment allows a relatively quick shift in center of mass and can be carried out in particular with devices that are typically already present and are movable, for instance a level control system.

The vehicle may have, for example, gas suspensions for the first axle unit and/or the second axle unit. The control device may include, for example, a valve arrangement, and a pressure and/or a gas quantity in the gas suspensions may be controllable via the valve arrangement such that the distance of the first axle unit relative to the vehicle frame and/or the distance of the second axle unit relative to the vehicle frame is changeable. This embodiment is particularly simple and reliable.

According to an embodiment, the vehicle has air suspensions as gas suspensions. Air suspensions are advantageous because they allow technically very simple level control. Air suspensions can also be used in a technically particularly simple way to control the axle loads. As an alternative to a gas suspension, it is possible to provide, for example, a fluid suspension in general, for example a liquid suspension or a combination of a gas suspension and a liquid suspension.

In principle, the change in the distance of the first axle unit relative to the vehicle frame and/or the change in the distance of the second axle unit relative to the vehicle frame can be achieved in different ways. For example, the pressure and/or a gas quantity in the gas suspension of the first axle unit can be reduced in order to reduce the distance of the first axle unit relative to the vehicle frame and thus to shift the center of mass of the vehicle toward the first axle unit. Alternatively or in addition, the pressure and/or a gas quantity in the gas suspension of the second axle unit can be increased in order to increase the distance of the first axle unit relative to the vehicle frame and thus to shift the center of mass of the vehicle toward the first axle unit. If the desire is to shift the center of mass toward the second axle unit, the opposite procedure could be carried out.

In conjunction with a level control system for the axle units, it is also possible, for example, for the pressure and/or a gas quantity of a gas suspension of the second axle unit to be reduced, for example simply by releasing gas. The pressure and/or a gas quantity of the gas suspension of the first axle unit can then be automatically increased by a level control in order to set a predetermined level of the vehicle. It is, for example, also possible for a fluid to be introduced into a gas or air bellows in order to increase an axle load, or released in order to reduce an axle load. Mechanical or electromechanical solutions for changing the distances are also conceivable.

The suspensions and valve arrangement may form or be included by a level control system of the vehicle. This is particularly advantageous because a predetermined level is thus maintained or at least quickly reached again after the distances between the axle units in question and the vehicle frame have been changed. Furthermore, if, to reduce the distance of the first axle unit, pressure and/or a gas quantity is simply released from a gas suspension of the first axle unit and then the level control is automatically activated, this represents a technically very simple solution. Precisely because a level control system is frequently already present in a vehicle, in particular a commercial vehicle, the disclosure can be realized in a particularly simple manner in combination with such a system.

In general, a gas suspension may be provided for individual axles or all the axles or individual axle units or all the axle units of the vehicle. Individual gas suspensions or all the gas suspensions may be controllable via the valve arrangement or the control device connected thereto. This allows flexible and targeted setting of the respective distances from the vehicle frame.

According to an embodiment, the vehicle includes a movable tool arm, in particular a load arm, wherein the control device is configured to shift the center of mass by moving the tool arm. The center of mass is shifted easily here too, in particular with means that are already present, for instance a tool arm of a self-propelled construction machine.

The dynamic operation to be carried out may be, for example, braking, acceleration, cornering or maintaining a given speed of the vehicle on an upward slope or a downward slope.

In principle, an axle unit may be an individual axle or an axle assembly. For the consideration of force effects in the vehicle, an axle unit should be understood as being a unit with an axle, which brings about, in a simplified manner, substantially selective power transmission. If the axle unit has a plurality of axles, that is, is an axle assembly, then these axles are arranged in particular relatively close together, such that, for the force effects, selective power transmission can be assumed in a simplified manner. The first axle unit can thus be an axle or an axle assembly and/or the second axle unit can be an axle or an axle assembly.

The vehicle includes preferably more than two axles, for example at least three, in particular at least four, in particular at least five axles. The numbering of “first” and “second” axle unit does not in principle relate to an order of the axles in the direction of travel, but serves only for easier reference. In principle, however, the first axle unit can be arranged in front of the second axle unit in the direction of travel, or vice versa.

According to an embodiment, the first dynamic unit includes an electric machine which forms both a drive and a brake. This provides advantageous functional integration and an overall simple configuration.

The first dynamic unit may be, for example, a brake, which is embodied as a sustained-action brake, in particular as a hydrodynamic retarder or as an electromechanical retarder, or as a recuperation brake. These types of brakes preserve the usually additionally required friction brakes of the vehicle with regard to wear and overheating. Thus, with the disclosure, friction brakes can be preserved even better, since a stronger and more reliable speed reduction can be achieved with the sustained-action brake or with the recuperation brake.

The brake can thus be embodied preferably as a sustained-action brake, for example as a hydrodynamic retarder or as an electromechanical retarder.

The brake can likewise be embodied preferably as a recuperation brake. A recuperation brake should be understood as being a device that brings about braking, wherein the device converts at least a part of the energy converted during braking into electrical energy and stores it, for example in a battery.

Typically, a recuperation brake is realized by an electric motor, which is configured both to drive the relevant axle and to have the function of a generator. In the case of a recuperation brake, the increase in the axle load has a positive effect on the amount of energy that can be recovered via recuperation. A recuperation brake can be activated, for example, by actuating a brake pedal, that is, a service brake, or by releasing an accelerator pedal. However, a recuperation brake can also be activated, for example, by actuating a sustained-action brake lever. Thus, a recuperation brake can in principle fulfill both a service braking function and a sustained-action braking function.

Without the disclosure, the electrically driven or recuperatively braked axle would spin or slip on the ground if a recuperation brake were used and in poor conditions. This results in the following two problems: First, the maximum recuperation power of the system is not utilized. In the braking operation, less energy is fed back into the battery via the recuperation brake, in particular an electric motor and inverter, than possible. This reduces the cost-effectiveness of operation of the vehicle, since energy that is available virtually free of charge is not used by recuperation. Secondly, the braking force is limited by the electric motor or the recuperation brake. This means that the friction brakes have to used more for braking, these then suffering greater wear and becoming hotter.

In any case, the increase in the axle load has a positive effect on the effectiveness of the brake. In principle, a plurality of brakes could also be provided. These can be assigned to different axles or the same axle. In principle, it is also possible for different types of brakes to be provided on the vehicle.

Typically, in vehicles of the type mentioned at the beginning, all the axles are equipped with a friction brake. This is frequently a requirement.

According to an embodiment, the vehicle includes a second dynamic unit, which is assigned to the second axle unit, wherein the control device is configured to ascertain a grip improvement request for the second axle unit and for a dynamic operation to be carried out via the second dynamic unit, and, in response to the grip improvement request for the second axle unit, to shift the center of mass toward the second axle unit. This further improves the grip and thus the power transmission. Depending on the axle unit at which a dynamic operation is required, the grip can thus be improved in a targeted manner. The vehicle may also have further dynamic units assigned to further axles.

The vehicle may be, for example, a single vehicle or a towing vehicle or a trailer, for example a semi-trailer or center-axle trailer, for a towing vehicle-trailer combination. In the case of a single vehicle, the shift of the center of mass is typically highly effective on account of advantageous dimensions and leverage effects.

In the case of a single vehicle, all the axles and axle units are those of the single vehicle. In principle, the vehicle may also be just a trailer or just a towing vehicle.

For example, the vehicle may be a commercial vehicle or a personal vehicle or a passenger car. The vehicle may be, for example, a road vehicle or a rail vehicle. The vehicle may be, for example, a freight transport vehicle or a passenger transport vehicle, for instance a bus. The vehicle may be, for example, a self-propelled work machine, for instance a construction machine.

The problem addressed by the disclosure is also solved by various methods according to the disclosure for controlling a vehicle, in particular a vehicle of the type described above.

The vehicle includes a first axle unit; a dynamic unit assigned to the first axle unit, wherein the dynamic unit is one of brake, drive and steering system; a second axle unit; and a center of mass. As described above, the vehicle may also have further axle units.

The method includes generating a grip improvement request for the first axle unit and for a dynamic operation to be carried out via the first dynamic unit, and shifting the center of mass toward the first axle unit in response to the grip improvement request for the first axle unit.

The method may include, for example, generating a dynamic-operation activation request. The grip improvement request can be generated in particular in response to the dynamic-operation activation request.

The dynamic-operation activation request can, in principle, be generated manually via a corresponding input device of the vehicle. Alternatively or additionally, the dynamic-operation activation request can be generated automatically, for example by a control device and/or a driver assistance system, in particular on the basis of sensor data and/or geodata and/or communication data.

Distances between an axle unit and a vehicle frame can likewise be controlled, for example, manually, for example via appropriately configured valve levers or switches, or, in particular, via a control device which, in particular, controls the distances automatically.

A dynamic-operation activation request may be or include, for example, a brake request, an acceleration request and/or a steering request. A dynamic-operation activation request is assigned in particular to a dynamic unit, in particular the first dynamic unit.

The generation of the dynamic-operation activation request may, in particular, include one or more of the following aspects.

The generation of the dynamic-operation activation request may include actuating or releasing a pedal which is assigned to the dynamic unit. The pedal may be, for example, an accelerator or a brake pedal.

The generation of the dynamic-operation activation request may include actuating or releasing a manual activation device which is assigned to the dynamic unit. The manual activation device may be, for example, a lever on a steering wheel of the vehicle, for example a retarder lever. Alternatively, a retarder can also be activated, for example, via a push button, for example to the left of the clutch pedal in the driver's footwell.

The generation of the dynamic-operation activation request may include actuating a manual steering element, in particular a steering wheel.

A dynamic-operation activation request may also be generated, for example, via a driver assistance system. For example, a driver assistance system may automatically generate a brake request, an acceleration request and/or a steering request. The driver assistance system may be, for example, a cruise control, distance control or an automated driving system.

In principle, several different dynamic-operation activation requests can also be generated, either simultaneously or one after another.

For the purposes of the present application, the generating of a dynamic-operation activation request includes an actual request for the dynamic operation in question, that is,, for example, an actual brake request, an actual acceleration request or an actual steering request. In the context of a dynamic-operation activation request, the grip improvement request or the shifting of the center of mass brings about, in particular, an improvement in grip during an actual dynamic operation.

Alternatively or additionally, the generating of the grip improvement request can also take place, for example, preventively. The grip improvement request is accordingly generated regardless of whether there is actually a traction restriction, and/or regardless of whether a dynamic operation is actually requested or carried out. Rather, a grip improvement request is automatically generated in particular when conditions exist that make an imminent dynamic operation probable and/or that are likely to affect traction during a dynamic operation. The term “probable” refers in this case to a probability of less than 1 and greater than 0. In other words, prevention is a matter of also taking precautions in cases in which there will not necessarily, but probably be a traction restriction and/or a dynamic operation. The preventive generation of the grip improvement request results overall in a further improved braking performance on average over a longer period of time.

The generating of the grip improvement request can take place depending on various aspects. The following aspects can be used individually or in combination.

For example, the generating of the grip improvement request may include identifying slip and/or slipping of tires of the vehicle, in particular of the first axle, and generating the grip improvement request depending on the slip and/or slipping. Slip or slipping can be identified, for example, via a speed sensor on the axle in question, in particular compared with a measured speed of another axle. Slip or slipping can be identified, for example, in the context of an anti-lock braking system and be used to generate the grip improvement request.

The generating of the grip improvement request may include, for example, identifying an upcoming curve, in particular the radius thereof, and generating the grip improvement request depending on the curve.

The generating of the grip improvement request may include, for example, identifying a speed of the vehicle, and generating the grip improvement request depending on the speed.

The generating of the grip improvement request may include, for example, identifying a weather condition in an environment of the vehicle, and generating the grip improvement request depending on the weather condition. Advantageous examples of such weather conditions are, for instance, an outside temperature and/or precipitation. With regard to the outside temperature, it is possible to use, for instance, a low temperature, which makes snowfall and/or a risk of black ice probable.

Precipitation can be identified, for example, via a rain sensor. In case of rain, it is possible, for example, for aquaplaning to impair traction. In principle, weather conditions can be identified, for example, via a sensor and/or be received as information via a communication system.

The generating of the grip improvement request may include, for example, identifying the time and/or date, and generating the grip improvement request depending on the time and/or date. For example, in a given date range, it can be assumed that it is cold and/or that it is winter and that this is likely to cause a deterioration in traction.

The generating of the grip improvement request may include, for example, identifying an inclination of the vehicle, and generating the grip improvement request depending on the inclination. For example, a downward slope can be identified via an inclination sensor.

The generating of the grip improvement request may include, for example, identifying a position of the vehicle and/or a predicted or planned route of the vehicle, and generating the grip improvement request depending on the position and/or route. The position can be identified, for example, via a global position detection system, for instance GPS. The position or route can be assigned, for example in a control device, to a position or route on an electronic map.

The generating of the grip improvement request may include, for example, identifying a feature of the transport infrastructure which the vehicle is approaching, and generating the grip improvement request depending on the feature. It is also possible for several features to be identified and taken into account. The feature or features can be identified, for example, via an electronic map, via an, in particular optical, sensor of the vehicle and/or via a communication device.

An example of such a feature is a curve. A further example of such a feature is a speed limit. A further example of such a feature is a traffic signaling device, for example a traffic light. A further example of such a feature is a traffic intersection, for example a roundabout, crossroads, or the like. A further example of such a feature is an upward slope and/or a downward slope. A further example of such a feature is a controlled-access highway exit. A further example of such a feature is an underlying surface condition, such as a condition of the road surface or a lack of a paved road.

It is possible, for example, for off-road scenarios to be identified, in which the vehicle is away from public and/or paved roads, in which case the axle load on the first axle can be increased.

For example, a “heat map” may be provided in a control device or the control device of the vehicle. The control device can identify whether the vehicle, by reference to an electronic map, is in an area in which there are potentially sections with a steep downward slope. The controller can identify whether the vehicle, by reference to an electronic map, is in an area with a large number of curves and/or in which a planned route has a large number of curves.

The generating of the grip improvement request may include, for example, identifying historical vehicle data with reference to a current, predicted and/or planned position and/or route of the vehicle, and generating the grip improvement request depending on the historical vehicle data. For example, historical routes and corresponding braking can be taken into account.

The generating of the grip improvement request may include, for example, the vehicle communicating with a device separate from the vehicle, in particular another vehicle and/or a piece of transport infrastructure. The generating of the grip improvement request may take place in particular depending on the communication. In particular, Car2X communication may be provided. Braking scenarios can thus be predicted or synchronized. The communication may include information about one or more of the above aspects, for instance environmental information, for example curves, position on a map, speed limits, traffic lights, roundabouts, crossroads, inclines, controlled-access highway approaches, et cetera.

In general, the control device can advantageously be configured to shift the center of mass if a strong dynamic operation is probable, planned or requested.

Furthermore, the degree of increase in the axle load of the first axle unit or the shifting of the center of mass may be variable. For example, if there are a plurality of indications or triggers of dynamic-operation activation requests and/or grip improvement requests, the increase in the axle load of the first axle unit may be greater than if there is only one indication or trigger. Thus, the grip improvement effect can be improved further in a targeted manner.

The methods described herein can be advantageously further developed on the basis of the embodiments and individual features of the vehicles described herein and vice versa.

### BRIEF DESCRIPTION OF DRAWINGS

The invention will now be described with reference to the drawings wherein:

FIG. 1 shows a vehicle;

FIG. 2 shows a vehicle;

FIG. 3 shows a vehicle;

FIG. 4 shows a vehicle;

FIG. 5 shows a towing vehicle-trailer combination;

FIG. 6 shows a vehicle;

FIG. 7 schematically shows a method for controlling a vehicle;

FIG. 8 schematically shows the generating of a dynamic-operation activation request;

FIG. 9 schematically shows the generating of a grip improvement request;

FIG. 10 schematically shows the shifting of a center of mass; and,

FIG. 11 shows a further vehicle.

### DETAILED DESCRIPTION

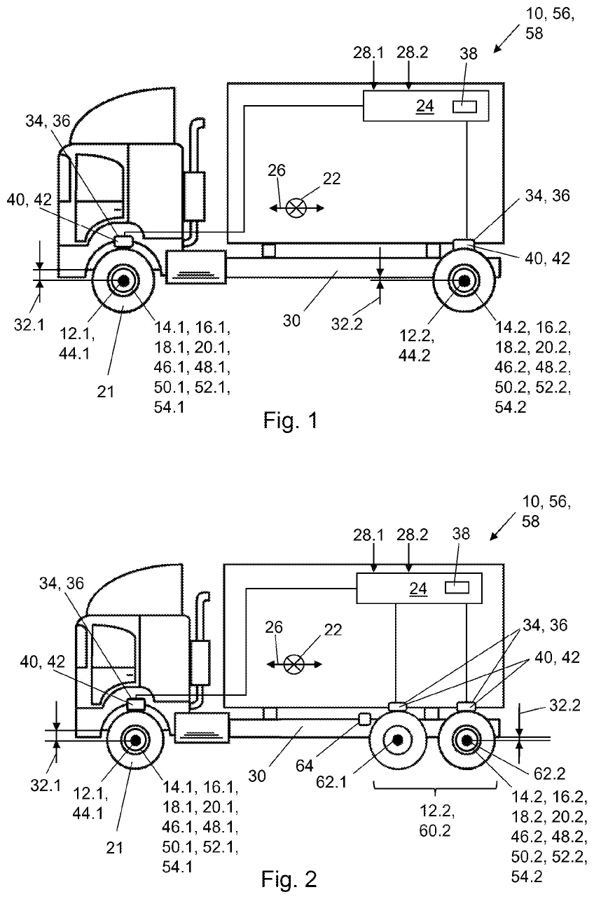

FIG. 1 shows a vehicle 10 including a first axle unit 12.1; a first dynamic unit 14.1 assigned to the first axle unit 12.1, wherein the first dynamic unit 14.1 is one of brake 16.1, drive 18.1 and steering system 20.1; a second axle unit 12.2. In this example, each axle unit 12 includes two tires 21.

The vehicle 10 includes a center of mass 22 and a control device 24, which is configured to shift the center of mass 22. The shifting 26 of the center of mass 22 is indicated by an arrow.

The control device 24 is configured to ascertain a grip improvement request 28.1 for the first axle unit 12.1 and for a dynamic operation to be carried out via the first dynamic unit 14.1 and, in response to the grip improvement request 28.1 for the first axle unit 12.1, to shift the center of mass 22 toward the first axle unit 12.1.

The vehicle 10 includes a vehicle frame 30, on which the first axle unit 12.1 and the second axle unit 12.2 are arranged. Via the control device 24, a distance 32.1 of the first axle unit 12.1 relative to the vehicle frame 30 and/or a distance 32.2 of the second axle unit 12.2 relative to the vehicle frame 30 is changeable. The control device 24 is configured to shift 26 of the center of mass 22 by changing the distance 32.1 of the first axle unit 12.1 relative to the vehicle frame 30 and/or the distance 32.2 of the second axle unit 12.2 relative to the vehicle frame 30.

The vehicle 10 has gas suspensions 34, in this example air suspensions 36, for the first axle unit 12.1 and the second axle unit 12.2. The control device 24 includes a valve arrangement 38. A pressure 40 and/or a gas quantity 42 in the gas suspensions 34 is controllable via the valve arrangement 38 such that the distance 32.1 of the first axle unit 12.1 relative to the vehicle frame 30 and/or the distance 32.2 of the second axle unit 12.2 relative to the vehicle frame 30 is changeable.

By changing the distance 32.1 and/or distance 32.2, the vehicle 10 tilts forward or backward. The center of mass 22 tilts forward or backward with the vehicle 10, that is, toward the first axle unit 12.1 or the second axle unit 12.2.

In the case of the vehicle 10 in FIG. 1, the first axle unit 12.1 is an axle 44.1 and the second axle unit 12.2 is an axle 44.2.

The vehicle 10 has a second dynamic unit 14.2, which is assigned to the second axle unit 12.1. The control device 24 is configured to ascertain a grip improvement request 28.2 for the second axle unit 12.2 and for a dynamic operation to be carried out via the second dynamic unit 14.2 and, in response to the grip improvement request 28.2 for the second axle unit 12.2, to shift the center of mass 22 toward the second axle unit 12.2.

The first dynamic unit 14.1 includes, for example, an electric machine 46.1, which forms both a drive 18.1 and a brake 16.1. The second dynamic unit 14.2 includes, for example, an electric machine 46.2, which forms both a drive 18.2 and a brake 16.2.

The first axle unit 12.1 may, for example, also be additionally assigned a steering system 20.1.

The brake 16.1 may be embodied, for example, as a sustained-action brake 48.1, in particular as a hydrodynamic retarder 50.1 or as an electromechanical retarder 52.1, or as a recuperation brake 54.1. The brake 16.2 may be embodied, for example, as a sustained-action brake 48.2, in particular as a hydrodynamic retarder 50.2 or as an electromechanical retarder 52.2, or as a recuperation brake 54.2.

The vehicle 10 in FIG. 1 is a single vehicle 56, in this example a truck for the transport of goods. The vehicle 10 may also be configured to tow a trailer, that is, form a towing vehicle 58 for a towing vehicle-trailer combination.

FIG. 2 shows a vehicle 10. Particular features compared with FIG. 1 will be described. Otherwise, the vehicle 10 can be embodied in the same way as the one in FIG. 1. Reference signs are assigned in a corresponding manner. For clarity, individual features or their reference signs may be omitted from the figure, although this does not mean that it is not possible for the features to be present.

The vehicle 10 in FIG. 2 has a second axle unit 12.2, which is embodied as an axle assembly 60.2. The axle assembly includes two axles 62.1 and 62.2. The axle 62.1 is embodied, for example, as a lift axle and includes a lift bellows 64. The first axle unit 12.1 is embodied as an axle 44.1.

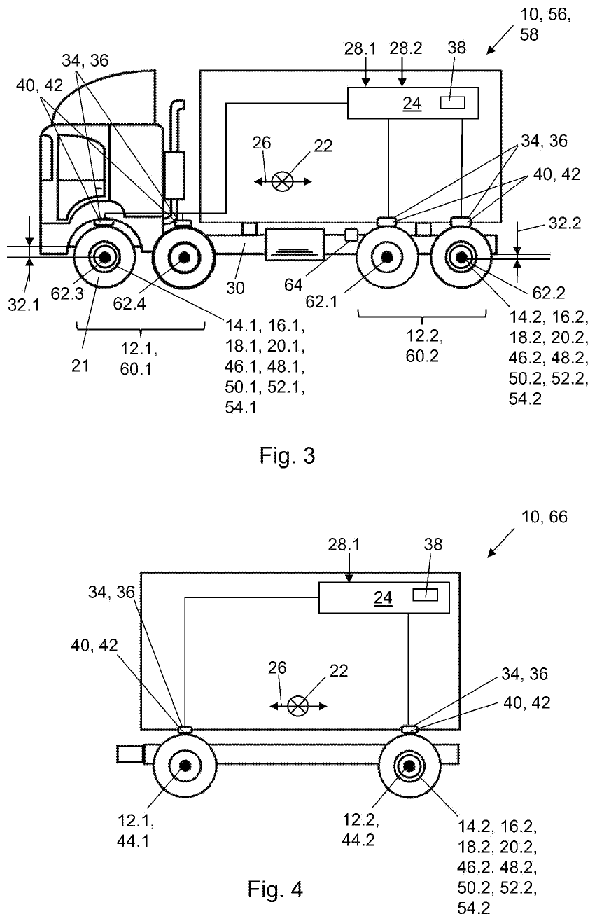

FIG. 3 shows a vehicle 10. Particular features compared with FIGS. 1 and 2 will be described. Otherwise, the vehicle 10 can be embodied in the same way as the one in FIG. 1 or 2. Reference signs are assigned in a corresponding manner. For clarity, individual features or their reference signs may be omitted from the figure, although this does not mean that it is not possible for the features to be present.

The vehicle 10 in FIG. 3 has a first axle unit 12.1, which is embodied as an axle assembly 60.1. The axle assembly 60.1 includes two axles 62.3 and 62.4. The vehicle 10 in FIG. 3 has a second axle unit 12.2, which is embodied as an axle assembly 60.2. The axle assembly 60.2 includes two axles 62.1 and 62.2. The axle 62.1 is embodied, for example, as a lift axle and includes a lift bellows 64.

FIG. 4 shows a vehicle 10. Particular features compared with FIGS. 1 to 3 will be described. Otherwise, the vehicle 10 can be embodied in the same way as the one in FIGS. 1 to 3. Reference signs are assigned in a corresponding manner. For clarity, individual features or their reference signs may be omitted from the figure, although this does not mean that it is not possible for the features to be present.

The vehicle 10 in FIG. 4 is embodied as a trailer 66. By changing the pressure 40 or gas quantity 42 in the gas suspensions 34, the vehicle 10 can be tilted slightly, and thus the center of mass 22 can be shifted as indicated by the arrow 26.

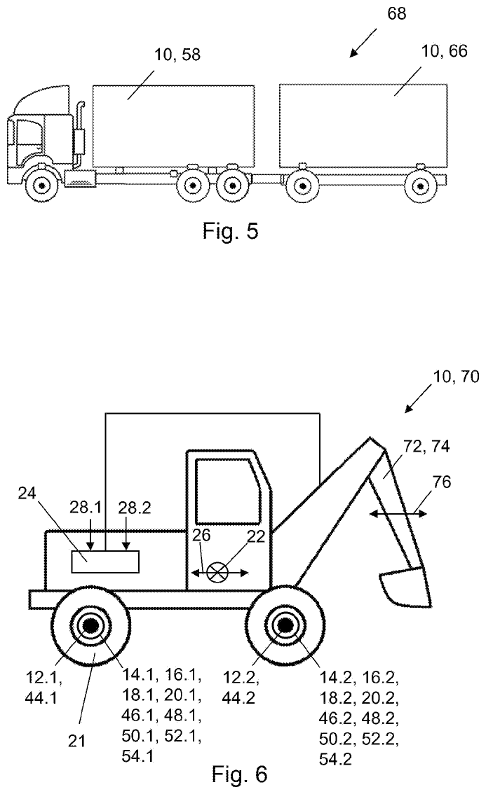

FIG. 5 shows a towing vehicle-trailer combination 68 including a towing vehicle 58, for example one as shown in one of FIGS. 1 to 3, and a trailer 66, for example one as shown in FIG. 4.

FIG. 6 shows a vehicle 10. Particular features compared with FIGS. 1 to 4 will be described. Otherwise, the vehicle 10 can be embodied in the same way as one of FIGS. 1 to 4. Reference signs are assigned in a corresponding manner. For clarity, individual features or their reference signs may be omitted from the figure, although this does not mean that it is not possible for the features to be present.

FIG. 6 shows a vehicle 10, which is embodied as a self-propelled construction machine 70. The vehicle 10 includes a movable tool arm 72, in this example a load arm 74. A control device 24 of the vehicle 10 is configured to move the tool arm 72, and to shift 26 the center of mass 22 by moving 76 the tool arm 24.

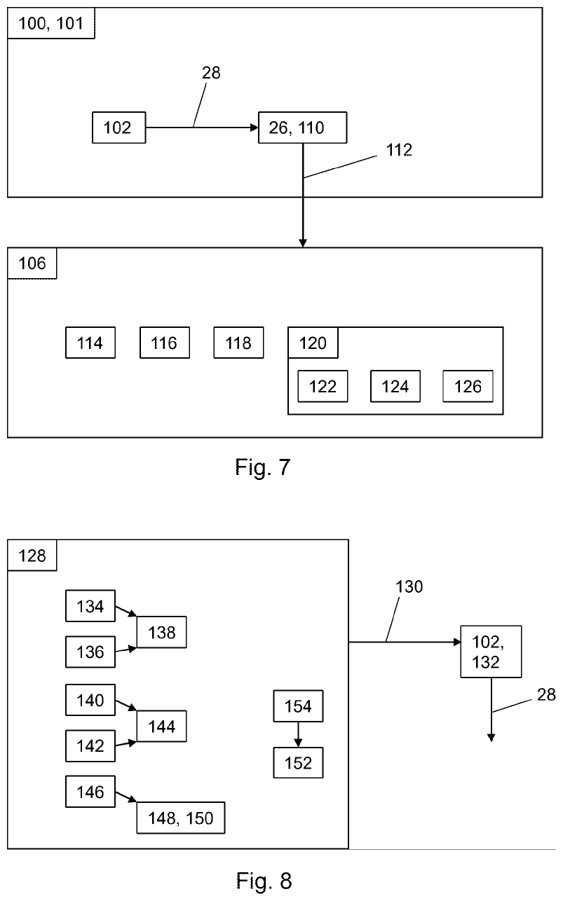

FIG. 7 shows a method 100 for controlling a vehicle, for example a vehicle 10 as shown in one of the figures described above. The vehicle includes a first axle unit; a dynamic unit assigned to the first axle unit, wherein the dynamic unit is one of brake, drive and steering system; a second axle unit; and a center of mass.

The method 100 includes generating 102 a grip improvement request 28 for the first axle unit and for a dynamic operation 106 to be carried out via the first dynamic unit.

The method 100 includes shifting 26 the center of mass toward the first axle unit in response 110 to the grip improvement request 28 for the first axle unit.

The shift 108 of the center of mass results in a grip improvement 112 for the dynamic operation 106 to be carried out. The dynamic operation 106 may be braking 114, acceleration 116, cornering 118 or maintaining 120 a given speed 122 of the vehicle on an upward slope 124 or a downward slope 126.

A corresponding procedure can be carried out for a grip improvement request for a second dynamic unit which is assigned to the second axle unit.

The generating 102 of the grip improvement request 112 can take place preventively.

FIG. 8 illustrates the generating 128 of a dynamic-operation activation request 130. This may be, for example, part of the method in FIG. 7, wherein the generating 102 of the grip improvement request 28 takes place in response 132 to the dynamic-operation activation request 130.

The generating 128 of the dynamic-operation activation request 130 includes one of:
actuating 134 or releasing 136 a pedal 138 which is assigned to the dynamic unit;
actuating 140 or releasing 142 a manual activation device 144 which is assigned to the dynamic unit;
actuating 146 a manual steering element 148, in particular a steering wheel 150, generating 152 a dynamic-operation activation request 130 via a driver assistance system 154.

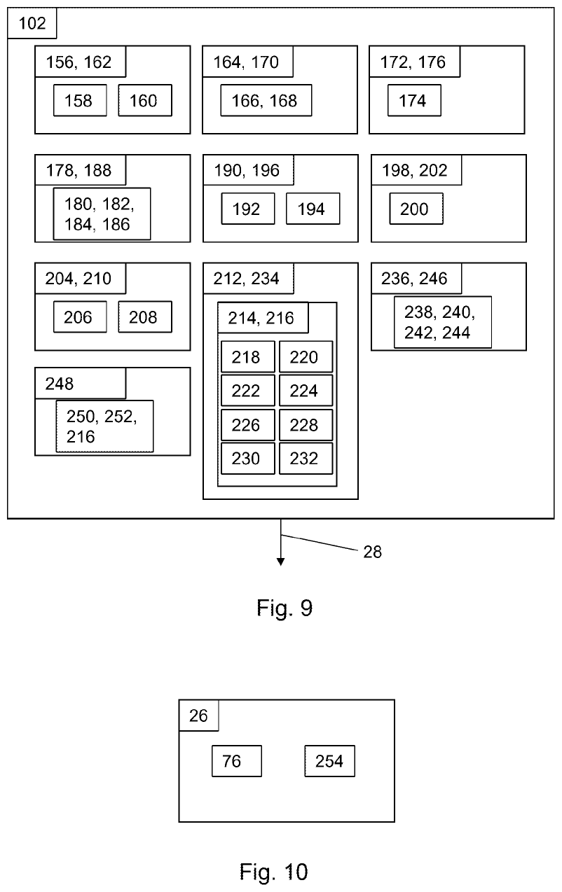

FIG. 9 illustrates the generating 102 of the grip improvement request 28, for example as is applied in FIG. 7. The generating 102 of the grip improvement request 28 may include one of the following aspects.

The generating 102 of the grip improvement request 28 may include identifying 156 slip 158 and/or slipping 160 of tires of the vehicle, in particular of the first axle unit, and generating 102 the grip improvement request 28 depending 162 on the slip 158 and/or slipping 160.

The generating 102 of the grip improvement request 28 may include identifying 164 an upcoming curve 166, in particular the radius 168 thereof, and generating 102 the grip improvement request 28 depending 170 on the curve 166.

The generating 102 of the grip improvement request 28 may include identifying 172 a speed 174 of the vehicle, and generating 102 the grip improvement request 28 depending 176 on the speed 174 of the vehicle 10.

The generating 102 of the grip improvement request 28 may include identifying 178 a weather condition 180 in an environment 182 of the vehicle, in particular an outside temperature 184 and/or precipitation 186, and generating 102 the grip improvement request 28 depending 188 on the weather condition 180.

The generating 102 of the grip improvement request 28 may include identifying 190 the time 192 and/or date 194, and generating 102 the grip improvement request 28 depending 196 on the time 192 and/or date 194.

The generating 102 of the grip improvement request 28 may include identifying 198 an inclination 200 of the vehicle, and generating 102 the grip improvement request 28 depending 202 on the inclination 200.

The generating 102 of the grip improvement request 28 may include identifying 204 a position 206 of the vehicle and/or a predicted or planned route 208 of the vehicle, and generating 102 the grip improvement request 28 depending 210 on the position 206 and/or route 208.

The generating 102 of the grip improvement request 28 may include identifying 212 a feature 214 of a piece of transport infrastructure 216 which the vehicle is approaching. The feature 214 may be or include, for example, a curve 218, a speed limit 220, a traffic signaling device 222, a traffic intersection 224, an upward slope 226 and/or a downward slope 228, a controlled-access highway exit 230, and/or an underlying surface condition 232. The generating 102 of the grip improvement request 28 may take place depending 234 on the feature 214.

The generating 102 of the grip improvement request 28 may include identifying 236 historical vehicle data 238 with reference 240 to a current, predicted and/or planned position 242 and/or route 244 of the vehicle, and generating 102 the grip improvement request 28 depending 246 on the historical vehicle data 238.

The generating 102 of the grip improvement request 28 may include the vehicle communicating 248 with a device 250 separate from the vehicle, in particular another vehicle 252 and/or a piece of transport infrastructure 216.

FIG. 10 illustrates the shifting 26 of a center of mass of a vehicle, for example one as shown in one of the figures described above. The shifting 26 of the center of mass may include moving 76 a movable tool arm. The shifting may alternatively or additionally include changing 254 a distance of a first axle unit relative to a vehicle frame and/or a distance of a second axle unit relative to a vehicle frame.

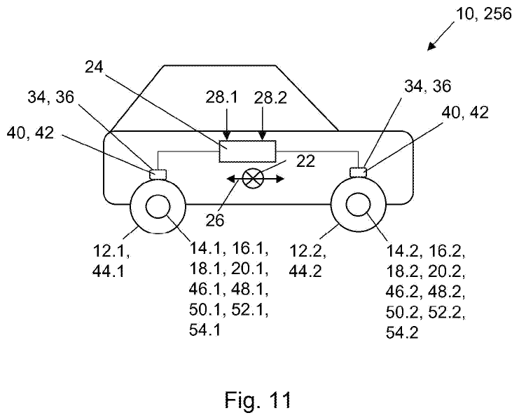

FIG. 11 shows a vehicle 10. Particular features compared with the figures described above will be described. Otherwise, the vehicle 10 can be embodied in the same way as one of FIGS. 1 to 6. Reference signs are assigned in a corresponding manner. For clarity, individual features or their reference signs may be omitted from the figure, although this does not mean that it is not possible for the features to be present. The vehicle 10 in FIG. 11 is embodied as a personal vehicle or as a passenger car.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

10 Vehicle
12 Axle unit
14 Dynamic unit
16 Brake
18 Drive
20 Steering system
22 Center of mass
24 Control device
26 Shifting
28 Grip improvement request
30 Vehicle frame
32 Distance
34 Gas suspension
36 Air suspension
38 Valve arrangement
40 Pressure
42 Gas quantity
44 Axle
46 Electric machine
48 Sustained-action brake
50 Hydrodynamic retarder
52 Electromechanical retarder
54 Recuperation brake
56 Single vehicle
58 Towing vehicle
60 Axle assembly
62 Axle
64 Lift bellows
66 Trailer
68 Towing vehicle-trailer combination
70 Self-propelled construction machine
72 Tool arm
74 Load arm
76 Moving
100 Method
101 Controlling
102 Generating
106 Dynamic operation
110 Response
112 Grip improvement
114 Braking
116 Acceleration
118 Cornering
120 Maintaining
122 Speed
124 Upward slope
126 Downward slope
128 Generating
130 Dynamic-operation activation request
132 Response
134 Actuating
136 Releasing
138 Pedal
140 Actuating
142 Releasing
144 Manual activation device
146 Actuating
148 Manual steering element
150 Steering wheel
152 Generating
154 Driver assistance system
156 Identifying
158 Slip
160 Slipping
162 Dependence
164 Identifying
166 Curve
168 Radius
170 Dependence
172 Identifying
174 Speed
176 Dependence
178 Identifying
180 Weather condition
182 Environment
184 Outside temperature
186 Precipitation
188 Dependence
190 Identifying
192 Time
194 Date
196 Dependence
198 Identifying
200 Inclination
202 Dependence
204 Identifying
206 Position
208 Route
210 Dependence
212 Identifying
214 Feature
216 Transport infrastructure
218 Curve
220 Speed limit
222 Traffic signaling device
224 Traffic intersection
226 Upward slope
228 Downward slope
230 Controlled-access highway exit
232 Underlying surface condition
234 Dependence
236 Identifying
238 Vehicle data
240 Reference
242 Position
244 Route
246 Dependence
248 Communication
250 Device
252 Vehicle
254 Changing
256 Personal vehicle/passenger car

1. A vehicle comprising:
a first axle unit;
a first dynamic unit assigned to said first axle unit, said first dynamic unit being selected from a group of a brake, a drive, and a steering system;
a second axle unit;
the vehicle having a center of mass;
a control device configured to shift the center of mass;
said control device being configured:
to ascertain a grip improvement request for said first axle unit and for a dynamic operation to be carried out via said first dynamic unit; and,
in response to the grip improvement request for said first axle unit, to shift the center of mass toward said first axle unit.

2. The vehicle of claim 1 further comprising:
a vehicle frame on which said first axle unit and said second axle unit are arranged; and,
said control device being configured to shift the center of mass by changing at least one of a distance of said first axle unit relative to said vehicle frame and a distance of said second axle unit relative to said vehicle frame.

3. The vehicle of claim 2 further comprising:
gas suspensions for at least one of said first axle unit and said second axle unit;
said control device including a valve arrangement; and,
said valve arrangement being configured to control at least one of a pressure and a gas quantity in said gas suspensions such that at least one of the distance of said first axle unit relative to said vehicle frame and the distance of said second axle unit relative to said vehicle frame is changeable.

4. The vehicle of claim 1 further comprising:
a movable tool arm; and,
said control device being configured to shift the center of mass by moving said movable tool arm.

5. The vehicle of claim 1, wherein the dynamic operation to be carried out is braking, acceleration, cornering, or maintaining a given speed of the vehicle on an upward slope or a downward slope.

6. The vehicle of claim 1, wherein at least one of:
said first axle unit is an axle or an axle assembly; and,
said second axle unit is an axle or an axle assembly.

7. The vehicle of claim 1, wherein said first dynamic unit includes an electric machine which forms both a drive and a brake.

8. The vehicle of claim 1, wherein said first dynamic unit is a brake embodied as a sustained-action brake.

9. The vehicle of claim 1 further comprising:
a second dynamic unit assigned to said second axle unit;
said control device being configured to:
to ascertain a grip improvement request for said second axle unit and for a dynamic operation to be carried out via said second dynamic unit; and,
in response to the grip improvement request for said second axle unit, shift the center of mass toward said second axle unit.

10. The vehicle of claim 1, wherein the vehicle is a single vehicle or a towing vehicle or a trailer for a towing vehicle-trailer combination.

11. The vehicle of claim 3, wherein said gas suspensions are air suspensions.

12. The vehicle of claim 4, wherein said movable tool arm is a load arm.

13. The vehicle of claim 8, wherein said first dynamic unit is a brake embodied as a hydrodynamic retarder, as an electromechanical retarder, or as a recuperation brake.

14. A method for controlling a vehicle, wherein the vehicle includes a first axle unit, a first dynamic unit assigned to the first axle unit, the first dynamic unit being selected from a group of a brake, a drive, and a steering system; the vehicle further including a second axle unit and having a center of mass, the method comprising:
generating a grip improvement request for the first axle unit and for a dynamic operation to be carried out via the first dynamic unit; and,
shifting the center of mass toward the first axle unit in response to the grip improvement request for the first axle unit.

15. The method of claim 14 further comprising:
generating a dynamic-operation activation request;
wherein said generating the grip improvement request takes place in response to the dynamic-operation activation request;
wherein said generating the dynamic-operation activation request includes one of:
actuating or releasing a pedal which is assigned to the first dynamic unit;
actuating or releasing a manual activation device assigned to the first dynamic unit;
actuating a manual steering element; and,
generating the dynamic-operation activation request via a driver assistance system.

16. The method of claim 14, wherein said generating the grip improvement request takes place preventively.

17. The method of claim 14, wherein said generating the grip improvement request includes one of:
identifying slip and/or slipping of tires of the vehicle and generating the grip improvement request depending on the identified slip and/or slipping;
identifying an upcoming curve, and generating the grip improvement request depending on the upcoming curve;
identifying a speed of the vehicle, and generating the grip improvement request depending on the speed of the vehicle;
identifying a weather condition in an environment of the vehicle and generating the grip improvement request depending on the weather condition;
identifying at least one of a time and a date and generating the grip improvement request depending on the at least one of the time and the date;
identifying an inclination of the vehicle, and generating the grip improvement request depending on the inclination;
identifying at least one of a position of the vehicle and a predicted or planned route of the vehicle and generating the grip improvement request depending on the at least one of the position and the predicted or planned route;
identifying a feature of a piece of transport infrastructure which the vehicle is approaching and generating the grip improvement request depending on the feature;
identifying historical vehicle data with reference to at least one of a current position, a current route, a predicted position, a predicted route, a planned position, and a planned route of the vehicle and generating the grip improvement request depending on the historical vehicle data; and,
the vehicle communicating with a device separate from the vehicle.

18. The method of claim 15, wherein the manual steering element is a steering wheel.

19. The method of claim 17, wherein at least one of:
the tires of the vehicle are of the first axle unit;
said identifying an upcoming curve includes identifying a radius of the curve;
the environment of the vehicle is at least one of an outside temperature and precipitation; and,
the device separate from the vehicle is another vehicle and/or a piece of transport infrastructure.

20. The method of claim 17, wherein the feature is at least one of
a curve;
a speed limit;
a traffic signaling device;
a traffic intersection;
an upward slope;
a downward slope;
a controlled-access highway exit; and,
an underlying surface condition.
